(19) United States
(12) Patent Application Publication
(10) Pub. No.: US 2006/0120773 A1
(43) Pub. Date: Jun. 8, 2006

(54) Image forming method and image forming apparatus

(76) Inventors: Akihiko Itami, Tokyo (JP); Masao Asano, Tokyo (JP)

Correspondence Address: SQUIRE, SANDERS & DEMPSEY L.L.P., 1 MARITIME PLAZA, SUITE 300, SAN FRANCISCO, CA, 94111, US

(21) Appl. No.: 11/004,640

(22) Filed: Dec. 3, 2004

(51) Int. Cl. G03G 15/01

(52) U.S. Cl. 399/302

(57) ABSTRACT

An image forming method, comprising steps of developing a latent image formed on an electro-photographic photosensitive member having a surface roughness Ra of 0.02 μm-0.1 μm with developer to form a toner image; transferring the toner image developed as a visual image in the developing step onto an intermediate transfer member having a surface roughness Rz of 0.4 μm-2.0 μm; transferring the toner image transferred onto the intermediate transfer member onto a recording material; removing residual toner remaining on the surface of the electro-photographic photosensitive member; and supplying a surface energy lowering agent onto the surface of the electro-photographic photosensitive member at least during an image forming process.

### BACKGROUND OF THE INVENTION

The present invention relates to image-forming methods and apparatus employed for a copying machine, a printer, a facsimile, etc.

Conventionally, as a method for transferring a toner image residing on an electro-photosensitive member (hereinafter, also referred to as a photoreceptor member, for simplicity) onto a recording material as a final image, there has been well-known a method for directly transferring the toner image formed on the electro-photosensitive member onto the recording material. On the other hand, there has been also well known an image-forming method employing an intermediate transfer member. According to this method, one more transferring operation is inserted in the process of transferring the toner image from the photoreceptor member to the recording material. Namely, after a primary transferring operation for transferring the toner image formed on the photoreceptor member onto the intermediate transfer member is completed, a secondary transferring operation for transferring the toner image residing on the intermediate transfer member onto the recording material is conducted to acquire the final image on the recording material. Among other things, the intermediate transferring method mentioned in the above is frequently employed as a multi-color overlapped transferring method in the full color image-forming apparatus, so to speak, in which a full color image is reproduced by using a subtractive color mixing process of black, cyan, magenta, yellow, etc., toners based on the color separation of the original image.

Even when employing any one of the abovementioned methods, however, a large number of copying operations or printing operations causes a toner-filming phenomenon on the photoreceptor member and/or the intermediate transfer member, and also causes a degradation of a toner transferability from the photoreceptor member and/or the intermediate transfer member to the recording material due to the increase of the toner adhesive force caused by the increase of the surface energy of the photoreceptor member and/or the intermediate transfer member, resulting in an easy occurrence of an image defect in the final image. Specifically in the intermediate transferring method mentioned in the above, since the toner image is transferred to the recording material through two transferring operations performed by two transferring means, namely, the primary transferring means for transferring the toner image formed on the photoreceptor member onto the intermediate transfer member and the secondary transferring means for transferring the toner image residing on the intermediate transfer member onto the recording material, the degradation of the toner transferability would considerably deteriorate a quality of the final image.

Concretely speaking, the degradation of the toner transferability is apt to cause the “inner portion omission (center dropout)” and/or the “character image scattering (blurred character)”, so to speak, which means inability of transferring a part of the toner image.

To improve the toner transferability to reduce the cause of “inner portion omission” and/or the “character image scattering”, the cleaning defect and to prevent the toner-filming phenomenon, a technique for reducing the toner adhesive force on the surface of the photoreceptor member by making fine particles included into the surface layer of the photoreceptor member to emboss the surface so as to improve the toner transferability, and/or a technique for reducing the friction force with the blade, have been considered conventionally. For instance, the technique for making the alkylsilsesquioxane-resin fine particles included into the photosensitive layer is set forth in Tokkaihei 5-181291 (Japanese Non-Examined Patent Publication). However, since the surface energy of the photoreceptor member increases due to the surface wettability, of the photoreceptor member under a high temperature and a high humidity environment, caused by hygroscopicity of the alkylsilsesquioxane-resin fine particles, there has been a problem that the toner transferability tends to be degraded. Further, the photoreceptor member, which includes fluororesin powder so as to decrease the surface energy of the photoreceptor member, is set forth in Tokkaisho 63-56658 (Japanese Non-Examined Patent Publication). It is impossible, however, to acquire a sufficient surface strength when employing the fluororesin powder, and therefore, there has been a problem that the striping defect caused by scars generated on the surface of the photoreceptor member is liable to occur.

On the other hand, to improve the toner transferability of the intermediate transfer member, there have been disclosed techniques for reducing the surface energy of the intermediate transfer member by supplying a solid-state lubricant onto the intermediate transfer member. Such the techniques are set forth in Tokkaihei 6-337598, Tokkaihei 6-332324, Tokkaihei 7-271142, (Japanese Non-Examined Patent Publications). On the contrary, however, such the reduction of the surface energy of the intermediate transfer member causes the degradation of the toner transfer rate from the photoreceptor member to the intermediate transfer member. Accordingly, such the techniques are insufficient for improving the toner transferability of the image-forming method employing the intermediate transfer member for performing the toner-image transferring process twice, and therefore, there has been found that still further improvements would be necessary especially for the image-forming operations over a long period and under a high temperature and a high humidity environment.

In other words, there has been found that it is necessary for the image-forming method employing the intermediate transfer member to improve a total transferability of both the primary transferring operation and the secondary transferring operation by improving the balance and other surface characteristics with respect to the surface energies of both the photoreceptor member and the intermediate transfer member.

To overcome the abovementioned drawbacks in conventional image-forming methods and apparatus, it is an object of an aspect in the present invention to provide image-forming method and apparatus, in which the toner transferability of the image-forming method employing the intermediate transfer member is improved so as to prevent the image-forming apparatus from generating the image defects, such as the “center dropout”, the “blurred character”, etc.

Accordingly, to overcome the cited shortcomings, the abovementioned object of the present invention can be attained by image-forming methods and apparatus described as follow.

### SUMMARY OF THE INVENTION

(1) A method for supplying a surface energy reducing agent onto a surface of an electro-photosensitive member during at least an image-forming operation performed in an image-forming apparatus, comprising the steps of:

developing a latent image formed on the electro-photosensitive member, surface roughness Ra of which is in a range of 0.02-0.1 μm, with developer;

transferring a toner image, developed as a visual image in the developing step, onto an intermediate transfer member, surface roughness Rz of which is in a range of 0.4-2.0 μm;

transferring the toner image, transferred onto the intermediate transfer member, onto a recording material;

removing residual toner remained on the surface of the electro-photosensitive member; and

supplying the surface energy reducing agent onto the surface of an electro-photosensitive member.

(2) An image-forming apparatus, comprising:

an electro-photosensitive member, surface roughness Ra of which is in a range of 0.02-0.1 μm;

a developing section to develop a latent image formed on the electro-photosensitive member;

an intermediate transfer member, surface roughness Rz of which is in a range of 0.4-2.0 μm and onto which a toner image, developed as a visual image by the developing section, is transferred; and

an agent supplying device to supply a surface energy reducing agent onto the surface of the electro-photosensitive member during at least an image-forming operation performed in the image-forming apparatus.

### BRIEF DESCRIPTION OF THE DRAWINGS

Other objects and advantages of the present invention will become apparent upon reading the following detailed description and upon reference to the drawings in which:

FIG. 1 shows a cross sectional schematic diagram of a color image-forming apparatus embodied in the present invention;

FIG. 2 shows an example of the cleaning means for cleaning the intermediate transfer member;

FIG. 3 shows a cross sectional schematic diagram indicating an arrangement of the photoreceptor member, the intermediate transfer endless-belt and the primary transferring roller;

FIG. 4 shows a cross sectional schematic diagram indicating an arrangement of a backup roller, the intermediate transfer endless-belt and the secondary transferring roller; and

FIG. 5 shows a cross sectional schematic diagram of the cleaning means, embodied in the present invention, to be disposed at a position around the photoreceptor member.

FIG. 6 is an illustration showing a measurement condition of surface roughness.

### DETAILED DESCRIPTION OF THE PREFERRED EMBODIMENT

The present inventors found that the above mentioned drawbacks in the conventional image-forming methods and apparatus employing the intermediate transfer member can be solved by applying the steps of: reducing the surface energy of the photoreceptor member; improving a primary transferability of a toner image on the surface of the photoreceptor member to the intermediate transfer member; and improving a secondary transferability of the toner image on the intermediate transfer member to a recording sheet by roughening the surface of the intermediate transfer member with a large period.

In other words, the present inventors found that occurrences of the “center dropout” and/or the “blurred character” and the deterioration of the sharpness can be prevented in the image-forming method and apparatus employing the intermediate transfer member and an excellent electro-photographic image can be formed by applying the steps of: making the surface characteristic of the photoreceptor member to sufficiently spread the surface energy reducing agent over the surface of the photoreceptor member; increasing the primary transferability of the toner image on the surface of the photoreceptor member to the intermediate transfer member by reducing the surface energy of the photoreceptor member; and reducing the contacting area of toner on the surface of the intermediate transfer member by roughening the surface of the intermediate transfer member with the large period, so as to improve the secondary transferability of the toner image on the intermediate transfer member to the recording sheet. Namely, the following method and apparatus will be effective for solving the abovementioned drawbacks.

An image-forming method is characterized in that,

in the image-forming method, which includes: a primary transferring process for developing a latent image formed on the electro-photosensitive member with developer and for transferring a toner image, developed as a visual image in the developing step, onto an intermediate transfer member; a secondary transferring process for transferring the toner image, transferred onto the intermediate transfer member, onto a recording material; and a cleaning process for removing residual toner remained on the surface of the electro-photosensitive member after transferring the toner image onto a recording material,

surface roughness Ra of the electro-photosensitive member is in a range of 0.02-0.1 μm and surface roughness Rz of the intermediate transfer member is in a range of 0.4-2.0 μm, and

a surface energy reducing agent is supplied onto the surface of the electro-photosensitive member when conducting an image-forming operation.

An image-forming apparatus comprises:

an electro-photosensitive member, surface roughness Ra of which is in a range of 0.02-0.1 μm;

a developing section to develop a latent image formed on the electro-photosensitive member;

an intermediate transfer member, surface roughness Rz of which is in a range of 0.4-2.0 μm and onto which a toner image, developed as a visual image by the developing section, is transferred;

a primary transferring means for transferring the toner image onto the intermediate transfer member

a secondary transferring means for transferring the toner image, transferred onto the intermediate transfer member, onto a recording material;

a cleaning means for removing residual toner remained on the surface of the electro-photosensitive member after transferring the toner image onto a recording material

an agent supplying device to supply a surface energy reducing agent onto the surface of the electro-photosensitive member during at least an image-forming operation performed in the image-forming apparatus.

According to the image-forming method and apparatus described in the above, it becomes possible not only to prevent the image-forming apparatus from generating the “center dropout”, the “blurred character” and/or the deterioration of the sharpness in the reproduced image, but also to contribute to provide excellent electro-photographic images formed by the image-forming method employing the intermediate transfer member.

The embodiment of the present invention will be detailed in the following.

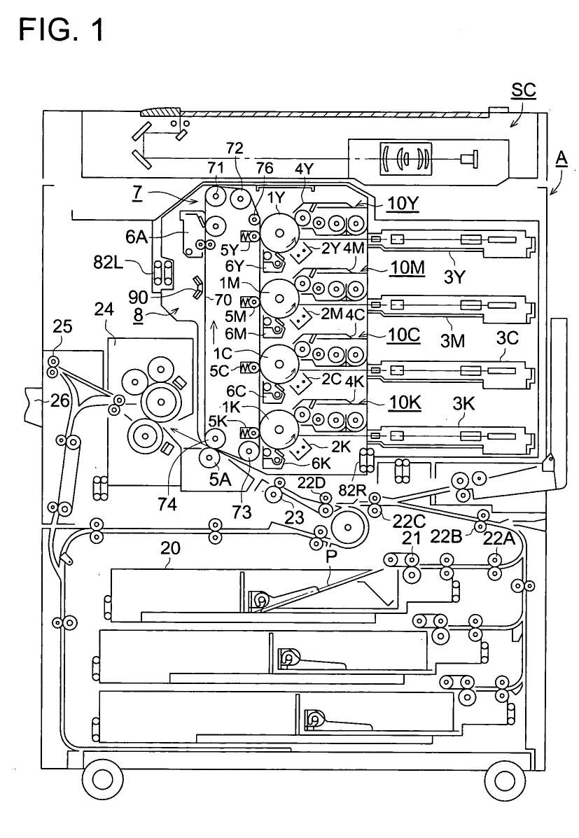

FIG. 1 shows a cross sectional schematic diagram of a color image-forming apparatus embodied in the present invention.

The color image-forming apparatus shown in FIG. 1 is denoted as a tandem-type color image-forming apparatus, which includes a plurality of image-forming sections 10Y, 10M, 10C, 10K, intermediate transfer unit 7 having an intermediate transfer belt shaped in a endless belt, sheet feeding/conveying means 21 and fixing means 24 (for performing a fixing operation). The original-document reading unit SC is disposed at the upper space of image-forming apparatus proper A.

The image-forming section 10Y for forming a color image of yellow has charging means 2Y (for performing a charging operation) disposed at a peripheral area of photoreceptor drum 1Y serving as a first image-bearing member, image exposing means 3Y (for performing an exposing operation), developing means 4Y (for performing a developing operation), primary transferring roller 5Y serving as a primary transferring means (for performing a transferring operation) and cleaning means 6Y (for performing a cleaning operation). The image-forming section 10M for forming a color image of magenta has photoreceptor drum 1M serving as a first image-bearing member, charging means 2M, image exposing means 3M, developing means 4M, primary transferring roller 5M serving as a primary transferring means and cleaning means 6M. The image-forming section 10C for forming a color image of magenta has photoreceptor drum 1C serving as a first image-bearing member, charging means 2C, image exposing means 3C, developing means 4C, primary transferring roller 5C serving as a primary transferring means and cleaning means 6C. The image-forming section 10K for forming a color image of magenta has photoreceptor drum 1K serving as a first image-bearing member, charging means 2K, image exposing means 3K, developing means 4K, primary transferring roller 5K serving as a primary transferring means and cleaning means 6K.

The intermediate transfer unit 7 has intermediate transfer endless-belt 70 circularly threaded on a plurality of rollers so as to serve as a second image-bearing member shaped in a semi-conductive endless belt.

The color images formed by image-forming sections 10Y, 10M, 10C, 10K are sequentially transferred onto intermediate transfer endless-belt 70 circularly moving along the image-forming sections by primary transferring rollers 5Y, 5M, 5C, 5K serving as the primary transferring means, in order to form a full color image by synthesizing the color images. A sheet P, accommodated in sheet feeding cassette 20 and serving as a recording medium, is fed by sheet feeding/conveying means 21, and is conveyed to second transferring roller 5A (for performing a secondary transferring operation) through a plurality of intermediate rollers 22A, 22B, 22C, 22D and registration roller 23 to collectively transfer the full color image onto sheet P as the secondary transferring operation. Then, sheet P, having the full color toner image-transferred, is conveyed to fixing means 24 to fix the full color toner image on it, and is further conveyed by ejecting rollers 25 so as to place sheet P on ejecting tray 26 disposed outside the apparatus.

On the other hand, cleaning means 6A removes residual toner remained on intermediate transfer endless-belt 70, from which sheet P is separated by using the curvature-separating action, after second transferring roller 5A, serving as a second transferring means, transfers the full color toner image onto sheet P.

During the image-forming operation, primary transferring roller 5K always press-contacts photoreceptor drum 1K, while other primary transferring rollers 5Y, 5M, 5C respectively press-contact photoreceptor drums 1Y, 1M, 1C only when the color image-forming operation is performed.

The second transferring roller 5A press-contacts intermediate transfer endless-belt 70 only when the secondary transferring operation is applied to sheet P passing through primary transferring roller 5A.

Further, housing unit 8 is drawable from image-forming apparatus proper A by moving it on supporting rails 82L, 82R.

The housing unit 8 includes image-forming sections 10Y, 10M, 10C, 10K and intermediate transfer unit 7.

The image-forming sections 10Y, 10M, 10C, 10K are aligned in parallel in a vertical direction. The intermediate transfer unit 7 is disposed at a left side space of photoreceptor drums 1Y, 1M, 1C, 1K as indicated in the schematic diagram shown in FIG. 1. The intermediate transfer endless-belt 70 circularly threaded on rollers 71, 72, 73, 74, primary transferring rollers 5Y, 5M, 5C, 5K and cleaning means 6A constitute intermediate transfer unit 7.

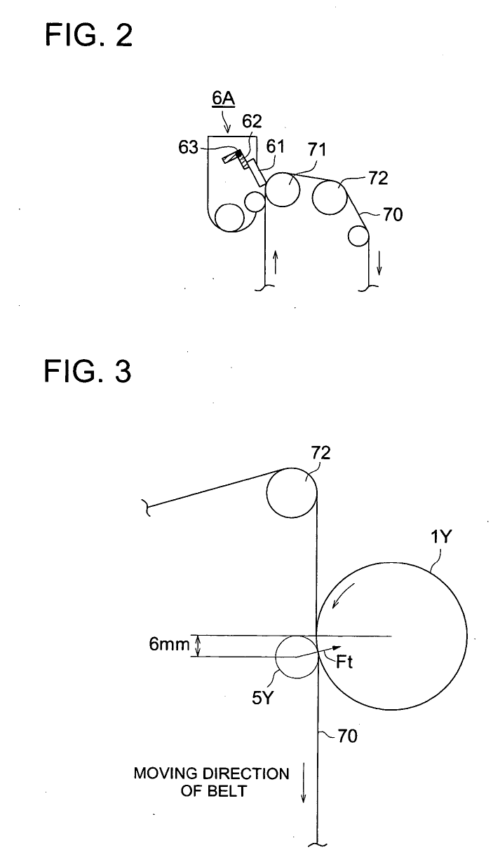

FIG. 2 shows an example of the cleaning means for cleaning the intermediate transfer member. As shown in FIG. 2, cleaning means 6A of the intermediate transfer member includes blade 61 attached to bracket 62, which can be rotatably controlled around shaft 63, so as to adjust a blade pressing force to be applied to roller 71 by changing a spring load or a weight load.

The image-forming sections 10Y, 10M, 10C, 10K and intermediate transfer unit 7 are integrally drawn out of image-forming apparatus proper A by the drawing operation of housing unit 8.

The supporting rails 82L of housing unit 8 located at a left side in the schematic diagram shown in FIG. 1 is disposed in an upper space of fixing means 24 and at a left side of intermediate transfer endless-belt 70. While the supporting rails 82R of housing unit 8 located at a right side in the schematic diagram shown in FIG. 1 is disposed in the vicinity of a lower space of developing means 4K located at the lowest position. The supporting rails 82R is disposed at such a position that developing means 4Y, 4M, 4C, 4K can be detachably mounted into housing unit 8 without any interference with supporting rails 82R.

As indicated in the schematic diagram shown in FIG. 1, the right side surfaces of photoreceptor drums 1Y, 1M, 1C, 1K included in housing unit 8 are surrounded by developing means 4Y, 4M, 4C, 4K, the lower side surfaces of them are surrounded by charging means 2Y, 2M, 2C, 2K and cleaning means 6Y, 6M, 6C, 6K, and the left side surfaces of them are surrounded by intermediate transfer endless-belt 70.

In the abovementioned configuration, the cleaning means, the charging means, etc. constitute a photoreceptor unit, while the developing means, a toner supplying device, etc. constitute a developing unit.

FIG. 3 shows a cross sectional schematic diagram indicating an arrangement of the photoreceptor member, the intermediate transfer endless-belt and the primary transferring roller. Each of primary transferring rollers 5Y, 5M, 5C, 5K, located at rear side of intermediate transfer endless-belt 70, press-contacts each of photoreceptor drums 1Y, 1M, 1C, 1K with intermediate transfer endless-belt 70 between them. As shown in FIG. 3, each of primary transferring rollers 5Y, 5M, 5C, 5K, is disposed at such a position that each of the press-contacting points is located downstream in a rotating direction of the photoreceptor drum, compared to each of contacting points of intermediate transfer endless-belt 70 and photoreceptor drums 1Y, 1M, 1C, 1K when primary transferring rollers 5Y, 5M; 5C, 5K are apart from the photoreceptor drums. When each of primary transferring rollers 5Y, 5M, 5C, 5K press-contacts each of photoreceptor drums 1Y, 1M, 1C, 1K, with intermediate transfer endless-belt 70 between them, intermediate transfer endless-belt 70 is bended along the outer surfaces of photoreceptor drums 1Y, 1M, 1C, 1K, and each of primary transferring rollers 5Y, 5M, 5C, 5K is located at a position of the most downstream side of the contacting area of the photoreceptor-drum and intermediate transfer endless-belt 70.

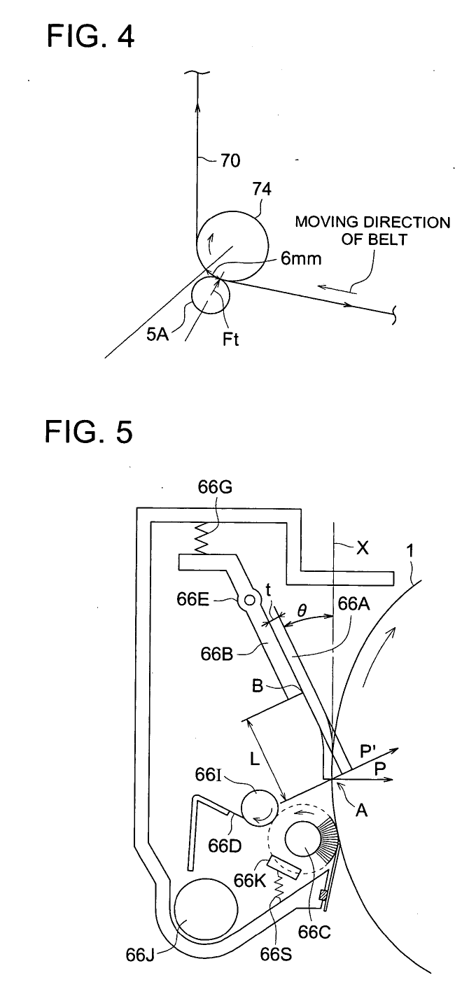

FIG. 4 shows a cross sectional schematic diagram indicating an arrangement of a backup roller, the intermediate transfer endless-belt and the secondary transferring roller. As shown in FIG. 4, it is desirable that second transferring roller 5A is disposed downstream in a rotating direction of backup roller 74, compared to a center position of the contacting area of intermediate transfer endless-belt 70 and backup roller 74.

It is desirable that the a material, made by doping an electro-conductive filler, such as carbon black, etc., into a synthetic rubber, such as a poly imide, a poly carbonate, a macromolecule film like a PVdF, etc., a silicone rubber, a fluorine rubber, etc., so as to give a electro-conductivity to the material, is employed for the intermediate transfer member. Although the intermediate transfer member can be shaped in either a drum or a belt, a belt shape would be preferable from a viewpoint of degree of apparatus design freedom.

By setting the surface roughness Rz of the intermediate transfer member at a value in a range of 0.4-2.0 μm, it becomes possible not only to decrease the toner adhesive force on the intermediate transfer member, but also to easily improve the secondary transferring rate of toner from the intermediate transfer member to the recording sheet. When the surface roughness Rz of the intermediate transfer member is smaller than 0.4 μm, the secondary transferring rate of toner from the intermediate transfer member to the recording sheet is liable to decrease. On the contrary, when the surface roughness Rz of the intermediate transfer member is greater than 2.0 μm, since the surface of the intermediate transfer member becomes excessively rough, the image defect, such as the “white dropout”, etc., is liable to occur in the toner image formed on the recording material.

As a method for roughening the surface of the intermediate transfer member, a method for roughening it by adding fine particles in a range of about 0.2-10 μm or an electro-conductive filler to a micromolecule film or a synthetic rubber, a method for roughening it by employing the sandblast machining for colliding fine particles onto the surface of the supporting member, etc., could be cited. However, the scope of the method for roughening the surface of the intermediate transfer member is not limited to the exemplified methods mentioned in the above.

The present invention is characterized in that the image-forming apparatus comprises an agent adding means for supplying the surface energy reducing agent onto the surface of the photoreceptor member. Although the agent adding means can be disposed at an appropriate position located around the peripheral area of the photoreceptor member, it is applicable that the agent adding means is equipped as a part of the charging means, the developing means or the cleaning means, in order to effectively use the mounting space within the apparatus. An example, in which the agent adding means is integrally mounted into the cleaning means, will be detailed in the following.

FIG. 5 shows a cross sectional schematic diagram of the cleaning means, embodied in the present invention, to be disposed at a position around the photoreceptor member. The cleaning means shown in FIG. 5 is employed as each of cleaning means 6Y, 6M, 6C, 6K shown in FIG. 1. As shown in FIG. 5, cleaning blade 66A is attached to supporting member 66B. An elastic rubber material, such as a polyurethane rubber, a silicon rubber, a fluorine rubber, a chloropylene rubber, a butadiene rubber, etc., as well-known materials, is employed as the material of cleaning blade 66A. Among other things, the polyurethane rubber is specifically preferable compared to the other rubbers, since its friction characteristic is superior to those of the other rubbers.

On the other hand, supporting member 66B is made of a metal plate or a plastic material. When employing the metal plate, a stainless-steel plate, an aluminum board or a vibration-suppression steel plate would be preferable.

It is desirable that the cleaning blade press-contacts the photoreceptor member in such a manner that the leading edge of the cleaning blade applies the load, directed toward a direction being opposite to the rotating direction of the photoreceptor member (namely, a counter direction), onto the surface of the photoreceptor member. As shown in FIG. 5, it is also desirable that the contacting action between the leading edge of the cleaning blade and the surface of the photoreceptor member creates a press-contacting area.

The desirable values of press-contacting load P applied to the photoreceptor member by the cleaning blade and its contacting angle θ are shown as follow.
P=5-40 N/m, θ=5°-35°

The press-contacting load P is defined as a vector value of press-contacting force P′ in a normal direction relative to tangent line X at the press-contacting point A of cleaning blade 66A and photoreceptor drum 1.

Further, the contacting angle θ is defined as an angle of tangent line X versus the surface line of the cleaning blade in a non-deformed state (indicated by the dotted line shown in FIG. 5). Numeral 66E indicates a rotating shaft, which makes the supporting member rotatable, while numeral 66G indicates a loading spring.

Still further, the free length L of the cleaning blade is defined as a length from the edge portion B of supporting member 66B to the leading edge of the cleaning blade in a non-deformed state. A preferable value of the free length L of the cleaning blade is in a range of 6-15 mm. Further, thickness “t” of the cleaning blade is preferably set at a value in a range of 0.5-10 mm. Incidentally, thickness “t” is measured in a direction orthogonal to the adhesive surface with supporting member 66B.

The cleaning means shown in FIG. 5 is equipped with brush roller 66C also having a function of the agent adding means. The brush roller 66C has not only a function of removing toner remained on photoreceptor drum 1 and recovering toner removed by cleaning blade 66A, but also a function as an agent adding means for supplying a surface energy reducing agent onto the surface of the photoreceptor member. Concretely speaking, brush roller 66C contacts the surface of the photoreceptor member in such a manner that brush roller 66C rotates in a direction being opposite to that of the photoreceptor member so as to remove the residual toner or paper particles attached to the photoreceptor member at its contacting point. At the same time, brush roller 66C conveys the toner removed by cleaning blade 66A so as to restore the removed toner into conveying screw 66J. In the toner conveying path as mentioned in the above, it is desirable that flicker roller 66I, serving as a removing means, contacts brush roller 66C so as to remove residual materials, such as toner, etc., transferred from photoreceptor member 1 to brush roller 66C. Further, the toner attached to the surface of flicker roller 66I is restored to conveying screw 66J by scraping the toner off flicker roller 66I by means of scraper 66D. The collected toner is took out of the apparatus as a waste matter, or is conveyed to the developing device through a recycling pipe (not shown in the drawings) for a recycle using operation of the toner. A metal pipe made of a stainless steel, an aluminum, etc., is preferably employed as a material for flicker roller 66I. On the other hand, an elastic plate, such as a phosphor bronze plate, a polyethylene terephthalate plate, a polycarbonate plate, etc., is preferably employed as a material for scraper 66D. Further, it is desirable that scraper 66D contacts flicker roller 66I in such a counter-contacting manner that the leading edge of scraper 66D forms an acute angle with respect to the rotating direction of flicker roller 66I.

Further, the surface energy reducing agent 66K (solid-state material made of a zinc stearate, etc.) is disposed in such a manner that loading spring 66S pushes it to brush roller 66C, so that rotating brush roller 66C scrubs surface energy reducing agent 66K, and supplies it onto the surface of the photoreceptor member.

Either a conductive or a semi-conductive brush roller is employed as brush roller 66C.

Although an optional material could be employed as a material of the brush of the brush roller, it is preferable to employ a fiber-formative macromolecule polymer having hydrophobicity and a high dielectric constant. For instance, a rayon, a nylon, a poly carbonate, a polyester, a methacrylate resin, an acrylic resin, a polyvinyl chloride, a poly vinylidene chloride, a polypropylene, a polystyrene, a poly vinyl acetate, a styrene-butadiene copolymer, a vinylidene chloride-acrylonitrile copolymer, a chloroethylene-vinyl acetate copolymer, a chloroethylene-vinyl acetate-maleic anhydride copolymer, a silicone resin, a silicone-alkyd resin, a phenol formaldehyde resin, a styrene-alkyd resin, a polyvinyl acetal (for instance, a polyvinyl butyral), etc., can be cited as such the macromolecule polymer. Such the binding resin can be employed independently or as a mixture of two or more than two kinds of materials. Specifically, the rayon, the nylon, the polyester, the acrylic resin and the polypropylene are preferable.

Either a conductive or a semi-conductive material is employed for the brush, and its specific resistance can be adjusted at an optional value by doping a low resistance material, such as a carbon, etc., into the material to be employed.

It is desirable that the specific resistance of a brush fiber of the brush roller is in a range of 10¹ Ωcm-10⁶ Ωcm when measuring it under the condition that the voltage of 500V is applied to both ends of a single brush fiber whose length is 10 cm in a room temperature and humidity (namely, temperature: 26° C., relative humidity: 50%).

Concretely speaking, it is desirable that brush fibers, each of which has the specific resistance in a range of 10¹ Ωcm-10⁶ Ωcm, are filled on the core metal, made of stainless steel or the like, of the brush roller. When the specific resistance is smaller than 10¹ Ωcm, a banding phenomenon or the like caused by discharging actions are liable to occur. While, when the specific resistance is greater than 10⁶ Ωcm, the electronic potential difference between the photoreceptor member and the brush roller decreases, and the reduced electronic-potential difference is liable to cause a cleaning defect.

It is preferable that a thickness of each of brush fibers to be employed for the brush roller is in a range of 5-20 denier. When the thickness of the single brush fiber is smaller than 5 deniers, it is impossible to sufficiently remove residual materials attached to the surface of the photoreceptor member due to an inability of producing sufficient scrubbing force. While, when the thickness of the single brush fiber is greater than 20 deniers, the hardened brush fibers not only hurts the surface of the photoreceptor member, but also progresses abrasion of the surface, resulting in a shortened life-time of the photoreceptor member.

Incidentally, the abovementioned term of “denier” is defined as a value acquired by measuring a weight of the single brush fiber having a length of 9000 m in a unit of g (gram)

The filling density of the brush fibers is set at a value in a range of 4.5×10²/cm²-2.0×10⁴/cm² (a number of brush fibers per 1 square centimeter). When the filling density is smaller than 4.5×10²/cm², sometimes, it is impossible to uniformly remove the residual matters from the surface of the photoreceptor member, since the scrubbing force is weakened due to a low stiffness of the fibers and the scrubbing action becomes uneven over the surface. While, when the filling density is greater than 2.0×10⁴/cm², sometimes, a defected image, having a fog caused by the sensitivity reduction, a black stripe caused by the scars, etc., would be produced, since the scrubbing force is strengthened due to the hardened fibers and the strengthened scrubbing force would wear out the photoreceptor member.

It is preferable that a “penetration amount” of the brush roller for the photoreceptor member is set at a value in a range of 0.4-1.5 mm. The “penetration amount” mentioned in the above means a load applied to the brush and generated by the relative action between the photoreceptor member and the brush roller. The load mentioned in the above is equivalent to the scrubbing force received from the brush when viewing from the photoreceptor member. Accordingly, to specify its range means that it is necessary to scrub the photoreceptor member with an appropriate force.

Hereinafter, the “penetration amount” mentioned in the above is defined as a penetration length of the fiber cut into the inside of the photoreceptor member, assuming that the fiber straightforwardly penetrates into the inside of the photoreceptor member without being bended by the surface of the photoreceptor member when the brush contacts the photoreceptor member.

Since the scrubbing force on the surface of the photoreceptor member onto which the surface energy reducing agent is supplied is weakened, when the “penetration amount” is smaller than 0.4 mm, sometimes, it is impossible to suppress the filming phenomenon of toner, paper particles, etc., occurring on the surface of the photoreceptor member, resulting in image defects, such as an unevenness, etc. While, when the “penetration amount” is greater than 1.5 mm, sometimes, since the scrubbing force generated by the brush is too strong, the abrasion loss of the photoreceptor member increases, and a fog caused by the sensitivity reduction is generated in the reproduced image, and further, a striping defect is generated in the reproduced image due to the scars generated on the surface of the photoreceptor member.

Although a metal material, such as a stainless steel, an aluminum, etc., a paper, a plastic, etc. could be employed for the core material of the brush roller, the scope of the material is not limited to the above-cited materials.

It is desirable that the brush roller is so constituted that the brush is adhered onto the surface of the core material with an adhesive layer between them.

Further, it is desirable that the brush roller rotates in such a direction that the contacting point of the brush roller and the photoreceptor member moves in the same direction as that of the photoreceptor member. If the brush roller rotates in a reverse direction compared to the above direction, sometimes, the toner removed by the brush roller contaminate the recording paper or the interior of the apparatus when an excessive amount of residual toner resides on the surface of the photoreceptor member.

Still further, when the brush roller and the photoreceptor member move in the same direction as mentioned in the above, it is preferable that a surface velocity ratio of both of them is set at a value in a range of 1 versus 1.1-1 versus 2. When a rotating velocity of the brush roller is lower than that of the photoreceptor member, a cleaning defect is liable to occur since the toner removing ability of the brush roller is deteriorated. While, when a rotating velocity of the brush roller is higher than that of the photoreceptor member, a blade bounding or a rolling up phenomenon is liable to occur since the toner removing ability of the brush roller is excessively heightened.

In the image-forming apparatus having the intermediate transfer member, it is desirable that the agent adding means is equipped in such a manner that the agent adding means contacts the surface of the photoreceptor member in order to supply the surface energy reducing agent onto the surface of the photoreceptor member.

Incidentally, it is desirable that the surface energy reducing agent is supplied once at a time when the photoreceptor member is rotated before the image-forming operation is commenced. Further, during the image-forming operation, the agent adding means could be disposed at an upstream side of the cleaning means, for the purposes of improving the toner removing ability and of continuously supplying the surface energy reducing agent onto the photoreceptor member. Alternatively, it is also applicable that the agent adding means is disposed at a position, for instance, between the charging means (the charging operation) and the cleaning means (the cleaning operation) before a new image-forming operation is commenced, for the purpose of continuously supplying the surface energy reducing agent onto the photoreceptor member. In such the case, from the viewpoint of uniformly supplying the agent to the photoreceptor member, it is desirable that a member (for instance, a blade) for uniformly leveling the surface energy reducing agent onto the photoreceptor member is equipped in the image-forming apparatus.

Hereinafter, the term of the “surface energy reducing agent” is defined as such a substance that sticks on the surface of the photoreceptor member so as to reduce the surface energy on it. Concretely speaking, it is defined as a material that increases a contact angle (a contact angle for pure water) on the surface of the photoreceptor member to more than 1° by sticking on the surface.

[Measurement of Contact-Angle]

To find the contact-angle on the surface of the photoreceptor member, a sample, which is stored for 24 hours under an environment of 30° C., 80% RH, is measured under the same environment by using the contact-angle meter (CA-DT/A-type: manufactured by KYOWA KAIMENKAGAKU Co. Ltd.).

Incidentally, although a fatty-acid metal salt or a fluorine contained resin could be cited as the surface energy reducing agent, a water content of such the material would increase under a high temperature and high humidity condition, due to hydrophilic group and impurities included in the material. When the water content increases, such the surface energy reducing agent cannot be uniformly spread over the surface of the photoreceptor member, resulting in an inability of exhibiting the aforementioned effects of the present invention. It is preferable that the water content of the surface energy reducing agent, embodied in the present invention, is equal to or smaller than 5.0%-by-mass-under the environment of 30° C., 80% RH as a high temperature and high humidity condition.

Further, the scope of the material serving as the surface energy reducing agent is not limited to the fatty acid metal salt or the fluorine contained resin. Any material, which increases the contact angle (a contact angle for pure water) on the surface of the photoreceptor member to more than 1°, would be applicable.

As the surface energy reducing agent, the fatty acid metal salt, serving as a material having spreadability and a capability of forming a uniform film onto the surface of the photoreceptor member, is the most preferable. Further, it is desirable that the fatty acid metal salt is a metal salt of saturated or unsaturated fatty acid having a carbon atom number of equal to or more than 10. For instance, an aluminum stearate, an indium stearate, a gallium stearate, a zinc stearate, a lithium stearate, a magnesium stearate, a sodium stearate, an aluminum paltimate and an aluminum oleate can be cited as the fatty acid metal salt, and more preferably, a metal salt paltimate.

Among the fatty acid metal salts cited in the above, such a fatty acid metal salt, whose a flow speed measured by a Flowmeter is high, has a high cleavage performance, and therefore, can effectively form a layer of the fatty acid metal salt on the surface of the photoreceptor member embodied in the present invention. It is preferable that the flow speed is in a range of 1×10⁻⁷-1×10¹, and most preferably, in a range of 5×10⁻⁴-1×10⁻¹. The flow speed mentioned in the above was measured by employing the Capillary Rheometer Shimazu Flowmeter “CFT-500” (manufactured by Shimazu Manufacturing Co. Ltd.).

Further, as another example of the solid-state material, a fluororesin powder of a polyvinylidene fluoride, a poly tetrafluoroethylene, etc., is preferable. It is desirable that such the solid-state material is shaped into a plate or a bar when employing it for the apparatus.

On the other hand, a moisture content of the surface energy reducing agent is measured by employing the Karl Fischer Moisture Titrators (manufactured by KYOUTO ELECTRONIC Manufacturing Co. Ltd; MKA-3p), after storing a sample material of the surface energy reducing agent in a Schale (a culture dish) under an environment of 30° C., 50% RH for 24 hours.

To reduce the moisture content of the surface energy reducing agent equal to or lower than 5.0%-by-mass, other than a method for controlling hydrophilic components and impurities included in the material, for instance, by employing a purification and/or a hydrophobic processing to reduce the moisture content under high temperature and humidity (30° C., 80% RH), it can be achieved by employing a method of mixing a moisture adjusting agent and/or a high temperature drying processing. It is preferable that the moisture content of the surface energy reducing agent mentioned in the above is in a range of 0.01-5.0%-by-mass, and further preferably, in a range of 0.05-3.0%-by-mass. When it is smaller than 0.01%-by-mass, on the contrary, the surface energy reducing agent is easily influenced by the environment change caused by the temperature raise, etc., during the copying operation, especially the humidity change depending on the location of the image-bearing member, and the selection of the material and the hydrophobic processing become difficult. When it is greater than 5.0%-by-mass, the “center dropout” and the “blurred character” are liable to occur.

The photoreceptor member embodied in the present invention is also characterized in that surface roughness Ra of the photoreceptor member is in a range of 0.02-0.1 μm. By forming subtle unevenness on the surface of the photoreceptor member so as to adjust surface roughness Ra in a range of 0.02-0.1 μm, it becomes possible not only to uniformly spread the surface energy reducing agent, fed from the surface energy feeding means, etc., over the surface of the photoreceptor member, but also to uniformly raise the contacting angle so as to uniformly reduce the surface energy of the photoreceptor member. As a result, it becomes possible not only to improve the toner transferability, the cleaning performance and the abrasion resistivity of the photoreceptor member, but also to prevent the blade front curling and generating the blade noise. On the other hand, when surface roughness Ra is smaller than 0.02 μm or greater than 0.1 μm, since the surface energy reducing agent-hardly spread uniformly over the surface of the photoreceptor member and is formed in an uneven thin film, the toner transferability from the photoreceptor member to the intermediate transfer member would be lowered and/or the unevenness would occur in the toner image transferred.

Further, by setting surface roughness Ra on the surface of the photoreceptor member at a value within the range mentioned in the above, even if toner having a strong adhesive force to the photoreceptor member, such as toner of small diameter particles, is employed, it becomes possible not only to improve the toner transferability, the cleaning performance and the abrasion resistivity of the photoreceptor member remarkably, but also to prevent the blade from curling and generating the blade noise.

As a method of forming the surface of the photoreceptor member having surface roughness Ra set at a value within the range mentioned in the above, it is preferable to dope inorganic particles, a number-average primary particle diameter of which is preferably in a range of 1-300 nm, more preferably in a range of 10-200 nm and most preferably in a range of 10-100 nm, into the surface layer of the photoreceptor member. When the number-average primary particle diameter is smaller than 1 nm, it is impossible to form fine unevenness on the surface of the photoreceptor member, and accordingly, a little improvement of the abovementioned toner transferability and the cleaning performance could be achieved. While, when the number-average primary particle diameter is greater than 300 nm, surface roughness Ra is liable to exceed 0.1, the surface layer is liable to absorb water molecules, and the cleaning defect is liable to occur.

As the inorganic particles, the number-average primary particle diameter of which is in the range of 1-300 nm, it is possible to preferably employ fine particles, such as silica, zinc oxide, titanium oxide, tin oxide, antimony oxide, indium oxide, bismuth oxide, indium oxide doped with tin, tin oxide doped with antimony and tantalum, zirconium oxide, etc. Specifically, hydrophobic silica, hydrophobic alumina and hydrophobic zirconium, surfaces of which are treated as hydrophobic, fine particles sintered silica, etc.

The number average primary particle diameter of the inorganic particles is defined by the number average of the Fere diameter according to the image analyzing of 300 primary particles randomly selected from an electron microscopic image with a magnitude of 10,000.

The hydrophobicity of the hydrophobic inorganic minute particles is preferably 50% or more in terms of methanol wettability that is a measure of wettability against methanol. In case that the hydrophobicity is not more than 50%, a surface layer easily absorb water, and therefore, adhesion force of toner becomes greater transfer ability of toner reduces, abrasion of cleaning blade is increased, and cleaning defect is easy to occur. Preferable hydrophobicity is 65% or more and more preferably 70% or more.

The methanol wettability representing hydrophobicity is, exemplified with silica, to evaluate the wettability of silica powder to methanol. Measurement of wettability is performed by the following methods. In this method, 0.2 g of silica fine powder is weighed and added to 50 ml of distilled water placed in a 250 ml beaker. Methanol is slowly added dropwise while slowly stirring from a burette of which top is immersed in the solution until entire silica fine powder are wet. When “a” (in ml) represents the amount of methanol required for making silica fine powder perfectly wet, the degree of hydrophobicity is calculated from the formula given (1):
Degree of hydrophobicity=a/(a+50)×100 (1)

The above-mentioned hydrophobic silica can be obtained by hydrophobilizing silica powder generated with a well-known wet method or a well-known dry process. Especially, a hydrophobic silica in which a so-called fumed silica generated by a dry process (vapor phase oxidation of a siliconized halogen compound) is processed with a hydrophobilizing agent is desirable, because water content adsorption sites are few. This is a product conventionally manufactured by well-known technology. For example, the technology utilizes a pyrolysis oxidation reaction in the hydrogen oxide flame of silicon tetrachloride gas, and an equation used as a fundamental is as follows.
SiCl₄+2H₂+O₂→SiO₂+4HCl

Moreover, in this manufacturing process, it is also possible to acquire a compound fine powder of silica and other metal oxides by using other metal halogenated compounds, such as an aluminium chloride or a titanium chloride, with a silicon halogenated compound.

The hydrophobilizing process of silica powder can be performed by the following conventionally well-known methods: a dry processing in which for silica fine powder dispersed in a state of a cloud by stirring, a hydrophobilizing process agent solution dissolved in alcohol is sprayed to the powder or an evaporated hydrophobilize process agent is contacted and is made to adhere to the powder, or a wet processing which distributes the silica powder in a solution and drops a hydrophobilize process agent and adhere to the powder.

A well-known compound can be used as the hydrophobilizing process agent, and a concrete example is listed below. Moreover, these compounds may be combined and used.

As a titanium coupling agent, tetrabutyl titanate, tetraoctyl titanate, isopropyltri isostearoyl titanate, isopropyltridodecylbenzenesulfonyl titanate, bis(dioctylpyrophosphate)oxyacetate titanate, etc. can be listed.

As a Silane coupling agent, γ-(2-aminoethyl) aminopropyltrimethoxysilane, γ-(2-aminoethyl) aminopropylmethyldimethoxysilane, γ-methacryloxypropyltrimethoxysilane, a N-beta-vinyl benzylaminoethyl-N-γ-aminopropyltrimethoxysilane hydrochloride, Hexamethyldisilazane, a methyltrimethoxysilane, a butyltrimethoxysilane, an isobutyl trimethoxysilane, a hexyltrimethoxysilane, a octyltrimethoxysilane, a decyltrimethoxysilane, a dodecyltrimethoxysilane, a phenyltrimethoxsilane, o-methylphenyl trimethoxysilane, p-methylphenyl trimethoxysilane, etc. are may be listed.

As a silicone oil, dimethylsilicone oil, methylphenylsilicone oil, amino-modified-silicone oil, etc. are may be listed.

As for these hydrophobilizing process agents, it is desirable to add 1 to 40 weight % for silica powder so as to cover the silica powder, and to add 3 to 30 weight % is more desirable.

Moreover, a hydrogenpolysiloxane compound may be used as the above-mentioned surface hydrophobilizing agent. Generally, as for this hydrogenpolysiloxane compound, the compound having a molecular weight of 1000-20000 may be obtainable, and its black spot occurrence prevention function is also good. Suitable effect can be obtained when methylhydrodienepolysilxane is used for the final surface treatment. Although the hydrophobilize process for silica fine powder was described above, fine powder such as alumina and zirconia can also be made into hydrophobicity by the same hydrophobilize process as silica fine powder. Moreover, the hydrophobilize of silica fine powder can also be carried out by a sintering process.

In the present invention, in the case where a surface layer of an organic photoreceptor is made to contain with a binder a hydrophobic silica to which the abovementioned hydrophobilizing process was carried out, the rate of silica particles to a binder on a surface layer may be used at 1 to 20 weight %, preferably 2 to 15 weight %, and more preferably 2 to 10 weight %. If the rate exceeds 20 weight %, a surface layer will become to easily absorb water content, as a result, the adhesion tendency with toner will increase, and the transferring ability and the cleaning ability for toner tend to lower.

On the other hand, if the rate is not more than 1 weight %, a cleaning failure and a lower of wear-resistant-will tend to occur.

Hereafter, the surface roughness Ra (arithmetic average roughness and Rz (ten-point average roughness) of this invention are explained (although JISB 0601-2001 ca be applied correspondingly, a reference length cutoff value is specified as follows).

Surface Roughness Ra

Only a reference length is sampled in the direction of that average line from a roughness curve, an X-axis is taken in the direction of the average line of this sampling part, and a Y-axis is taken in the direction of longitudinal magnification, and Ra is represented with the micrometer (μm) of the value calculated by the following formula, when the roughness curve is expressed with y=f(x).
Ra=1/l∫o¹|f(x)|dx

In this invention, 1 is 2.5 mm and a cutoff value is 0.08 mm.

Ten-Point Surface Roughness Rz

The ten-point surface roughness Rz is a difference between an average height of five peaks from the highest peak and an average lowness of five valleys from the lowest valley within the distances of 2.5 mm of the reference length.

It was measured as a measurement machine by the surface roughness meter (Surfcorder SE-30H made by a Kosaka Laboratory Ltd. company). However, as long as an instrument produces the same result within allowable errors, other instruments may be used.

The Measurement Condition of Surface Roughness

Measurement speed (Drive speed: 0.1 mm/(second))

Measurement needle diameter (Stylus: 2 μm)

The surface roughness Ra is 0.02 μm or more and 0.1 μm or less, preferably, it may be 0.03 μm or more and 0.06 μm or less. On the other hand, although Rz of an intermediate transfer member is 0.4-2.0 μm, it is 0.5-1.5 μm preferably.

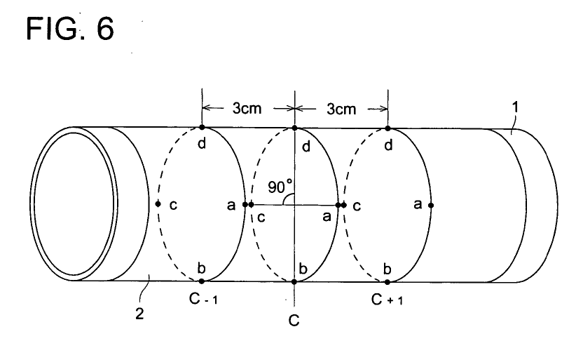

Here, the surface roughness Ra of a photoreceptor and the surface roughness Rz of an intermediate transfer member are calculated as mean value of the following method. Here, the average roughness Ra and Rz are explained using FIG. 6. Firstly, a position C, positions C−1 and C+1 are set such that the position C is located at a central portion on an image forming region 2 on a photoreceptor 1 and the positions C−1 and C+1 are located distant by 3 cm from the position C respectively. Then, 4 measurement positions are set so as to be the right angle with the neighboring one on the sectional plane of each of the positions C, C+1 and C−1. Accordingly, roughness is measured for 12 positions of Ca, Cb, Cc, Cd, C+1a, C+1b, C+1c, C+1d, C−1a, C−1b, C−1c, C−1d and the average roughness is an average value of the measured values of the roughness. Incidentally, even if the intermediate transfer member is a belt-like photoreceptor, measurement of the surface roughness is performed similarly.

As an electrophotographic photoreceptor, an organic photoreceptor which is easy to develop for formation of a color picture image with a digital method by an intermediate transfer member method is desirable. That is, in the organic photoreceptor, it is easy to develop a material suitable for laser widely used for an image formation of a digital method, or for LED light exposure wavelength. The organic photoreceptor is the most suitable for the electrophotographic photoreceptor of the present invention. Hereafter, the structure of an organic photoreceptor is described.

The organic photoreceptor is an electrophotographic photoreceptor in which one of the charge generation function and the charge transfer function essential for constituting the electrophotographic photoreceptor is charged with an organic compound, which entirely includes photoreceptors such as those constituted by a known charge generation material or a known charge transfer material and those in which the charge generation function and the charge transfer function are also charged on a high molecular weight complex.

The layer structure of the organic photoreceptor is composed of light sensitive layers, such as a charge generation layer, a charge transporting layer, or electric charge generating/charge transporting layer (layer which has the function of electric charge generating and electric charge transportation in the same layer) provided on a conductive base support fundamentally. The structure of having coated a surface layer which has the layer characteristics of this invention on the light sensitive layer may be used, however, the most desirable structure is the structure in which the light sensitive layer is constituted from a charge generation layer and plural charge transporting layers and the charge transporting layer of a top layer is made as the surface layer of this invention. Practical example of the photosensitive layer composition is described.

Electroconductive Support

An electroconductive support having a sheet shape or cylinder shape is used.

The cylindrical electroconductive support is a cylindrical support on which an images can be endlessly formed by its rotation. The electroconductive support having a straightness of not more than 0.1 mm and a swing width of not more than 0.1 mm is preferred. When the circular degree and the swinging exceed the above range, the suitable image formation is become difficult.

A drum metal such as aluminum or nickel, a plastic drum on the surface of which aluminum, tin oxide or indium oxide is provided by evaporation, and a plastic and paper drum each coated with an electroconductive substance may be used as the material of an electroconductive support. The specific electric resistively of the electroconductive support is preferably not more than 10³ Ωcm.

The electric conductive support having sealing processed alumite coating at the surface may be employed in the invention. The alumite processing is conducted in acidic bath such as chromic acid, oxalic acid, phosphoric acid, boric acid sulfamic acid etc., and anodic oxidation process in sulfuric acid provides most preferable result. Preferred condition for the anodic oxidation process in sulfuric acid is, for example, sulfuric acid content of 100 to 200 g/l, aluminum ion content of 1 to 10 g/l, bath temperature of around 20° C., and applying voltage of around 20 V. Thickness of the anodic oxidation coating is usually 20 μm or less, particularly 10 μm or less is preferable in average.

Interlayer

In the present invention, an interlayer, functioning as a barrier, may be provided between the electrically conductive support and the photosensitive layer.

It is preferable that the intermediate layer includes titanium oxide in the aforementioned binder resin whose absorption coefficient is small. The average particle diameter of the titanium oxide particles is preferably in the range between 10 nm and 400 nm and more preferably in the range between 15 nm and 200 nm in terms of the number-based average primary particle diameter. If the size is smaller than 10 nm the effect of preventing Moire generation in the intermediate layer is small. On the other hand, if the size exceeds 400 nm, occurrence of precipitation of the titanium oxide particles in the intermediate layer coating solution becomes likely, and as a result, the uniform distribution of the titanium oxide particles in the intermediate layer becomes poor, and also an increase in black spotting is likely to occur. The intermediate layer coating solution using titanium oxide particles for which number-based average primary particle diameter is in the range defined above is favorable, and the intermediate layer that is formed from this type of coating solution functions to prevent the generation of black spotting, and in addition, is favorable in terms of environmental properties and its resistance to cracking.

The titanium oxide particles may have a dendrite, needle shaped, or granular configuration, and the titanium oxide particles having these configurations may for example be a crystalline type such as an anatase type, a rutile type or an amorphous type for the titanium oxide crystal. Any of the crystal types may be used, and 2 or more of the crystal types may be mixed and used. Among these, the rutile type and the granular type are most favorable.

It is preferable that the titanium oxide particles of the present invention undergo surface treatment, and one surface treatment involves carrying out multiple surface treatments, and the last of the multiple surface treatments is one in which a surface treatment using a reactive organic silicon compound is carried out. In addition at least one of the plurality of surface treatments is one in which surface treatment with at least one substance selected from alumina, silica, and zirconia is done, and it is preferable that the surface treatment using the organic silicon compound is carried out at the last step.

The alumina treatment, the silica treatment and the zirconia treatment are each the treatment for precipitating alumina, silica and zirconia on the surface of the titanium oxide, respectively. The alumina, silica and zirconia precipitated onto the surface each include the hydrated compound thereof, respectively. The surface treatment by the reactive organic silicon compound is a treatment employing the reactive organic silicon compound.

The surface of the titanium oxide particle can be uniformly covered by two or more times of the treatments. The titanium oxide particles can be suitably dispersed in the intermediate layer and the good photoreceptor not causing image defect such as the black spots can be obtained by the use of such the treated titanium oxide particles in the intermediate layer.

Examples of the reactive organic silicon compound include the compounds represented by the following Formula (1), but any compounds capable of reacting with the reactive group on the surface of the titanium oxide such as a hydroxyl group are usable.
(R)ₙ—Si—(X)₄₋ₙ Formula (1)

wherein R represents an organic group in which a carbon atom directly bonds to a silicon atom, X represents a hydroxyl group or a hydrolyzable group, and n represent an integer of 0 to 3.

In organic silicon compounds represented by General Formula (1), listed as organic groups represented by R, in which the carbon atom directly bonds to the silicon atom, are Alkyl groups, such as the methyl, ethyl, propyl, butyl, pentyl, hexyl, octyl, and dodecyl, and the like; an aryl group such as phenyl, tolyl, naphthyl, biphenyl, and the like; an epoxy containing group such as g-glycidoxypropyl, b-(3,4-epoxycyclohexyl)ethyl, and the like; an acryloyl or methacryloyl containing group such as g-acryloxypropyl, and g-methacryloxypropyl; a hydroxy containing group such as g-hydroxypropyl, 2,3-dihydroxypropyloxypropyl, and the like; a vinyl group-containing group such as a vinyl group and a propenyl group; a mercapto group-containing group such as a g-mercaptopropyl group; amino containing group such as g-aminopropyl, N-b(aminoethyl)-g-aminopropyl and the like; a halogen containing group such as g-chloropropyl, 1,1,1-trifluoropropyl, nonafluorohexyl, perfluorooctylethyl and the like. Further, listed as hydrolizable groups represented by X are an alkoxy group such as methoxy, ethoxy, and the like, a halogen atom, and an acyloxy group.

Further, organic silicon compounds represented by General Formula (1) may be employed individually or in combinations of two or more types.

Further, in the specific organic silicon compounds represented by General Formula (1), when n is at least 2, a plurality of R may be the same or different. In the same manner, when n is not more than 2, a plurality of X may be the same or different. Still further, when at least two types of organic silicon compounds represented by General Formula (1) are employed, R and X, in each compound, may be the same or different.

Polysiloxane compounds may be employed as a reactive organic silicon compound used in surface treatment. The hydrodienepolysiloxane having a molecular weight of from 1,000 to 20,000 is usually available and shows satisfactory black spot preventing effect.

Suitable effect can be obtained when methylhydrodienepolysilxane is used for the final surface treatment.

Light Sensitive Layer

Charge Generating Layer

A charge generating layer contains a charge generating material (CGM). In addition, the charge generating layer may contain a binder resin and other additives as necessary. As the charge generating material (CGM), for example, phthalocyanine pigment, azo pigment, a perylene pigment, an azulenium pigment can be applied.

In case of using a binder as a dispersing medium of a CGM in the charge generating layer, a known resin can be employed for the binder, and the most preferable resins are butyral resin, silicone resin, silicone modification butyral resin, phenoxy resin. The ratio between the binder resin and the charge generating material is preferably binder resin 100 weight part for charge generating material 20 to 600 weight part. Increase in residual electric potential with repeated use can be minimized by using these resins.

The layer thickness of the charge generating layer is preferably in the range of 0.01 to 2 mm.

Charge Transporting Layer

A charge transporting layer is made the structure of plural charge transporting layers, and it may be preferable that the outermost layer of the charge transporting layers is arranged as a surface layer.

A charge transporting layer contains a charge transporting material (CTM) and a binder resin for dispersing the CTM and forming a layer. In addition, the charge transporting layer may contain additives such as an antioxidant agent as necessary.

As a charge transporting material (CTM), a known charge transporting material (CTM) can be used. For example, triphenylamines, hydrazones, styryl compound, benzidine compound, butadiene compound can be applied. These charge transporting materials are usually dissolved in a proper binder resin to form a layer. Among these, CTMs which can minimize increase in residual electric potential due to repeated use have a high mobility and a characteristic that the ionization potential difference from that of a CGM to be combined is not greater than 0.5 eV, and preferably not greater than 0.30 eV.

An ionization potential of CGM and CTM can be measured with a surface analysis apparatus AC-1 (a product made in Riken Keiki company).

As binder resin used for Charge transporting layer (CTL), any resin of thermoplastic resin and thermosetting resin can be used. For example, polystyrene, acryl resin, methacrylic resin, vinyl chloride resin, vinyl acetate resin, polyvinyl butyral resin, epoxide resin, polyurethane resin, phenol resin, polyester resin, alkyd resin, polycarbonate resin, silicone resin, melamine resin range and copolymer resin including more than repetition units of two resins among these resins may be usable. Further, other than these insulation-related resin, high polymer organic semiconductor such as poly-N-vinyl carbazole may be usable. The most preferred material is polycarbonate resin in view of, smaller water absorbing rate, dispersing ability of the CTM and electrophotosensitive characteristics.

Ratio of the binder resin is preferably 50 to 200 parts by weight to 100 parts of charge transporting material by weight.

Further it is preferable that film thickness of the charge transporting layer is 10-50 mm. Charging potential may be insufficient when the layer is not more than 10 mm, and sharpness may deteriorate when the thickness exceeds 50 mm.

As a solvent or a dispersion medium used for forming an intermediate layer, a photosensitive layer and a protective layer, n-butylamine, diethylamine, ethylenediamine, isopropanolamine, triethanolamine, triethylenediamine, N,N-dimethylformamido, acetone, methyl ethyl ketone, methyl isopropyl ketone, cyclohexanone, benzene, toluene, xylene, chloroform, dichloromethane, 1,2-dichloroethane, 1,2-dichloropropane, 1,1,2-trichloroethane, 1,1,1-trichloroethane, trichloroethylene, tetrachloroethane, tetrahydrofuran, dioxolan, dioxane, methanol, ethanol, butanol, isopropanol, ethyl acetate, butyl acetate, dimethyl sulfoxide and methyl cellosolve may be listed. The present invention is not restricted to these, dichloromethane, 1,2-dichloro ethane and methyl ethyl ketone are used preferably. Further, these solvents or dispersion media may also be used either independently or as mixed solvents of two or more types.

As a coating method for manufacturing an organic electrophotographic photoreceptor, there are used coating methods for immersion coating, spray coating and coating of a circular amount control type, however, it is preferable to use the coating method for spray coating or for coating of a circular amount control type (represented by a circular slide hopper type) so that a membrane of a lower layer may not be dissolved to the utmost by the coating operation for the upper layer in the photosensitive layer and uniform coating may be attained. Further, for the protective layer, it is preferable to use a coating method of a circular amount control type. The coating method of a circular amount control type is described in detail in, for example, JP-A No. 58-189061.

The electrophotographic photoreceptor according to the invention is suitable for an electrophotographic photoreceptor, a laser printer, a LED printer and a liquid crystal shutter type printer. Moreover, the photoreceptor can be widely applied to an apparatus utilizing electrophotographic technology for display, recording, light printing, plate making and facsimile.

### EXAMPLES

Although examples are given and this invention is hereafter explained to details, the aspect of this invention is not limited to this. Incidentally, “weight part” is expressed as the “part” in this specification.

### Example

Manufacture of Photoreceptor 1

On the cylinder type aluminum drum, immersion coating of an intermediate layer liquid in which 20 part of titanium chelate compound “TC-750” (made by Matsumoto Chemical Industry Co., Ltd. company) and 13 part of silan coupling agent “KBM-503” (made by Shin-Etsu Chemical Co., Ltd. company) were dissolved in 100 parts of a mixed solvent of (isopropanol:water=100:3) was carried out, and heating hardening was carried out at 150 degree-C.; for 30 minutes, thereby an intermediate layer of 1.0 μm of dried coating thickness was prepared.

Moreover on that drum, a coating solution in which six parts of titanylphthalocyanine pigments which has Bragg angle 2 theta of 9.5 degrees, 24.1 degrees, and 27.2 degrees in an X-ray diffractometry, 7 parts of silicone resin “KR-5240” (made by Shin-Etsu Chemical Co., Ltd. company), and 200 parts of acetic acid t-butyl were dispersed as electric charge occurrence substance by using a sand grinder is coated with the immersion coating, thereby a charge generation layer of 0.3 μm of thickness of dried coating was formed.

Subsequently, a coating solution in which 200 parts of electric charge transportation substance (CT-1), five parts of antioxidants (AO-1), and 300 parts of a bisphenol Z type polycarbonate “PANLITE TS-2050” (Teijin Chemicals manufactured by) and 2000 parts of 1,2-dichloroethane were dissolved was coated on the charge generation layer with a ring shaped slide hopper, thereby the first charge transporting layer of 19 μm of thickness of dried coating was formed.

Next, a coating solution in which 200 parts of electric charge transportation substance (CT-1), 5 parts of antioxidants (AO-1), 300 parts of a bisphenol Z type polycarbonate “PANLITE TS-2050” (Teijin Chemicals manufactured by), and 50 parts of hydrophobilize process silica (number average particle diameter of 20 nm) were dissolved, was coated on the charge generation layer with a ring shaped slide hopper, thereby the second charge transporting layer of 5 μm of thickness of dried coating was formed, and Photoreceptor 1 was produced. Surface roughness Ra of Photoreceptor 1 was 17.4 nm.
Electric Charge Transportation Substance (CT-1) 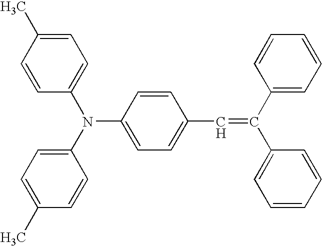
Antioxidants (AO-1) 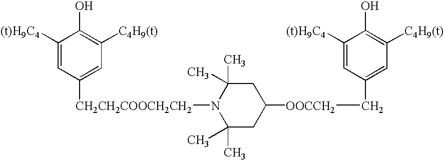
Manufacture of Photoreceptor 2

In production of Photoreceptor 1, except that hydrophobilize process silica (number average particle diameter of 20 nm) of the second charge transporting layer was replaced with hydrophobilize process silica (number average particle diameter of 45 nm), Photoreceptor 2 was produced in the similar way with Photoreceptor 1. Surface roughness Ra of Photoreceptor 2 was 34.5 nm.

Manufacture of Photoreceptor 3

In production of Photoreceptor 1, except that hydrophobilize process silica (number average particle diameter of 20 nm) of the second charge transporting layer was replaced with hydrophobilize process titanium oxide (number average particle diameter of 35 nm), Photoreceptor 3 was produced in the similar way with Photoreceptor 1. Surface roughness Ra of Photoreceptor 3 was 23.5 nm.

Manufacture of Photoreceptor 4

In production of Photoreceptor 1, except that hydrophobilize process silica (number average particle diameter of 20 nm) of the second charge transporting layer was replaced with hydrophobilize process zirconia (number average particle diameter of 62 nm), Photoreceptor 4 was produced in the similar way with Photoreceptor 1. Surface roughness Ra of Photoreceptor 4 was 47.3 nm.

Manufacture of Photo Conductor 5

In production of Photoreceptor 1, except that hydrophobilize process silica (number average particle diameter of 20 nm) of the second charge transporting layer was replaced with hydrophobilize process alumina (number average particle diameter of 100 nm), Photoreceptor 5 was produced in the similar way with Photoreceptor 1. Surface roughness Ra of Photoreceptor 5 was 73.6 nm.

Manufacture of Photoreceptor 6

In production of Photoreceptor 1, except that hydrophobilize process silica (number average particle diameter of 20 nm) of the second charge transporting layer was replaced with fine powder sintering silica (number average particle diameter of 0.13 μm), Photoreceptor 6 was produced in the similar way with Photoreceptor 1. Surface roughness Ra of Photoreceptor 6 was 97.3 nm.

Manufacture of Photoreceptor 7

In production of Photoreceptor 1, except that hydrophobilize process silica (number average particle diameter of 20 nm) of the second charge transporting layer was replaced with fine powder sintering silica (number average particle diameter of 0.25 μm), Photoreceptor 7 was produced in the similar way with Photoreceptor 1. Surface roughness Ra of Photoreceptor 7 was 111 nm.

Manufacture of Photoreceptor 8

In production of Photoreceptor 1, except that hydrophobilize process silica (number average particle diameter of 20 nm) of the second charge transporting layer was eliminated, Photoreceptor 8 was produced in the similar way with Photoreceptor 1. Surface roughness Ra of Photoreceptor 8 was 1.6 nm.

Number average particle diameters, such as colloidal silica used for production of the above-mentioned photoreceptors 1-8, are measurement values measured as follows: particles are magnified by 10000 times by a transmission type electron microscope observation, 100 particles are observed as primary particles at random from the magnified particles, and the direction mean Fere diameter of the primary particles was measured by an image analysis.

Manufacture of Surface Energy Drop Agent A-E

Sodium stearate is dissolved in water, thereby 15 wt % liquid was produced. Further, zinc sulfate was dissolved in water, thereby 25 wt % liquid was produced. A receiving container of 2 liters with a stirring apparatus having turbine blade of diameter 6 cm was prepared, and turbine blade was turned in 350 rpm. A sodium stearate liquid is put into this carrier container, and the solution temperature was adjusted to 80° C. Next, zinc sulfate liquid which was heated to 80° C. was dropped into this receiving container t for 30 minutes. An equivalence ratio of sodium stearate and zinc sulfate was made 0.98, sodium stearate and zinc sulfate were mixed for the purpose of quantity of metallic soap slurry becoming 500 g. After the preparation for total amount was completed, it was matured for 10 minutes under the temperature condition at the time of reaction, and then the reaction was completed. Next, the metallic soap slurry obtained in this way was twice washed with water, successively, it was washed by means of water. The obtained metallic soap cake was dried with the drying temperature of 110° C., and it was solidified by the pressure of 15 MPa. Thereafter, it was left alone under 30° C., 80% RH of environmental conditions for 24 hours, and a solid material (surface energy lowering agent A-E) of zinc stearate in which water content shown in Table 1 was changed was obtained. The water contents of A-E were adjusted by changing a drying time of 110° C.

TABLE 1

| Kind of Surface Energy | Material |
|---|---|
| Lowering Agent | (Water content: wt %) |
| A | zincstearate(0.05) |
| B | zincstearate(0.1) |
| C | zincstearate(1.0) |
| D | zincstearate(2.5) |
| E | zincstearate(4.5) |

Production of an Intermediate Transfer Member

Six kinds of intermediate transfer members were produced by suing an endless belt (volume resistivity is 1×108 ohm-cm) of a silicone rubber in which carbon black was mixed and by changing the surface roughness of the belt to Rz (μm) 0.3, 0.5, and 1.0, 1.5, 1.9 and 2.2 by a sand-blast processing would be preferable.

<Evaluation>

With respect to the combinations of the photoreceptor member, the intermediate transfer member, the surface energy reducing agent and the penetration amount of the cleaning brush, which are incorporated in the digital color printer as shown in FIG. 1, the performance of the cleaning means, shown in FIG. 5, which is equipped in the digital color printer having the intermediate transfer member shown in FIG. 1 as a cleaning means of the photoreceptor member, was evaluated by continuously printing an image whose pixel ratio is 8% onto 100,000 A4 papers under the environment of high temperature and high humidity (30° C., 80% RH). The evaluation items include evaluations of the “center dropout” and the “blurred character”, evaluations of the cleaning performance, evaluations of the printed image, etc. The evaluation results are indicated in Table 2.

Evaluation Items and Evaluation Criteria

Surface roughness Ra on the surface of the photoreceptor member and Rz of the intermediate transfer member were measured and evaluated by employing the aforementioned methods.

Measurement of Contacting Angle of Photoreceptor Member

After the evaluating operation of the 100,000 prints mentioned in the above had been completed, the contact-angle for the pure water on the surface of the photoreceptor member was measured under the environment of 30° C., 80% RH by using the contact-angle meter (CA-DT/A-type: manufactured by KYOWA KAIMENKAGAKU Co. Ltd.)

The six Japanese characters (which means “occurrence of blurred character”) formed on the 100,000 prints were enlarged for observation, so as to inspect the presence or absence of an occurrence of the “blurred character” in the prints by the visual observation of the inspector.

The evaluation criteria were as follow.

Excellent: No considerable “blurred character” could be found until all of 100,000 prints were completed.

Good: No considerable “blurred character” could be found until initial 50,000 prints were completed.

Bad: A considerable “blurred character” could be found until initial 50,000 prints were completed.

“Evaluation of the Blurred Character”

Instead of the dot image constituting the character, the 10%-mesh-dot image was formed all over the image, so as to observe toner scattering around the dot by using a magnifying lends.

Excellent: A little toner scattering could be found until all of 100,000 prints were completed.

Good: A little toner scattering could be found until initial 50,000 prints were completed.

Bad: Toner scattering had increased until initial 50,000 prints were completed.

“Evaluation of the Cleaning Performance”

The presence or absence of an occurrence of the toner slipping-through phenomenon, caused by the abrasion between the photoreceptor member and the cleaning blade, and the presence or absence of an occurrence of the blade curling (the blade reversing phenomenon) were inspected and evaluated.

Excellent: No toner slipping-through phenomenon and no blade curling could be found until all of 100,000 prints were completed.

Good: No toner slipping-through phenomenon and no blade curling could be found until initial 50,000 prints were completed.

Bad: The toner slipping-through phenomenon and the blade curling could be found until initial 50,000 prints were completed.

“Halftone Unevenness”

After all of 100,000 prints were completed, the evaluation of the halftone unevenness was conducted by employing the density difference (ΔHD=maximum density−minimum density) of a halftone image area (a uniform-tone image area having a density around 0.5). Densities of 20 positions located in a non-printed paper (a white paper) were measured as absolute image densities by using the Macbeth “RD-918” reflection densitometer. Then, the average value of the densities measured in the above was defined as the white paper density. Further, densities of 20 positions located in the halftone image area were measured as absolute image densities, as well. Then, the halftone unevenness was evaluated by employing ΔHD (=the maximum density−the minimum density, both found from the densities measured in the above).

Excellent: ΔHD is equal to or smaller than 0.05.

Good: ΔHD is greater than 0.05 and smaller than 0.1.

Bad: ΔHD is equal to or greater than 0.1.

“Sharpness of the Image”

The reproductivity of the fine lines and the sharpness of the image were evaluated by observing the “crushed character” in the image formed under the environment of high temperature and high humidity (temperature: 33° C., relative humidity: 50%). Then, after forming character images of 3 points and 5 points, the “sharpness of the image” was evaluated on the basis of the following criteria.

Excellent: The characters of both 3 points and 5 points were clear and easily readable.

Good: Some of the characters of 3 points were illegible, but the characters of 5 points were clear and easily readable.

Bad: All of the characters of 3 points were almost illegible, and some of or all of the characters of 5 points were illegible.

“Other Evaluating Conditions”

Line velocity of image-forming operation L/S: 180 mm/s

Charging condition of photoreceptor member (60 mmφ): The electronic potential at a non-image area was detected by the electronic-potential sensor, so that it was controlled in the feedback control mode. The controllable potential range was from −500 V to −900 V, and the surface potential of the photoreceptor member in the case of the full exposing operation was set at a value in a range of −50-0 V.
Image exposing light: semiconductor laser (wavelength: 780 nm)

Developing condition: The developer for each of Y, M, C, K colors was the two-component developing agent including carriers and toner having a number-average particle diameter of 7.5 μm. The developing device corresponded to the developer mentioned in the above.

Intermediate transfer member: The intermediate transfer member, which was seamless and shaped in an endless belt, was employed.

Primary Transferring Condition

Primary transferring roller (5Y, 5M, 5C, 5K, shown in FIG. 1, each diameter: 6.05 mmφ): the structure having the core metal covered with the elastic rubber: the specific resistance of the surface 1×10⁶ Ω, applying the transferring voltage.

Secondary Transferring Condition

The intermediate transfer endless-belt 70, serving as an intermediate transfer member, backup roller 74 and second transferring roller 5A were disposed in such a manner that backup roller 74 press-contacted second transferring roller 5A with intermediate transfer endless-belt 70 between them. The resistance value of backup roller 74 was 1×10⁶ Ωand that of second transferring roller 5A was 1×10⁶ Ω, and both of them were controlled in a constant current controlling mode (about 80 μA).

The thermal fixing method, using a fixing roller in which a heater is disposed, was employed for the fixing operation. The distance Y on the intermediate transfer member, from an initial contacting point of the intermediate transfer member and the photoreceptor member to another initial contacting point of the intermediate transfer member and the next photoreceptor member of next color, was set at 95 mm.

The circumferential length (the circumference) of each of driving roller 71, guide rollers 72, 73 and backup roller 74 for the secondary transferring operation was set at 31.67 mm (=95 mm/3), and that of tension roller 76 was set at 23.75 mm (=95 mm/4).

Further, the circumferential length of the primary transferring roller was set at 19 mm (=95 mm/5).

Cleaning means for photoreceptor member; the cleaning blade: elastic rubber material, the cleaning brush: conductive acrylic resin, the brush fiber density: 3×10³ cm², the penetration amount: employing 3 types of 0.6, 1.0 and 1.3 mm.

Secondary transferring roller (5A shown in FIG. 1): the structure having the core metal covered with the elastic rubber: applying the transferring voltage.

Cleaning means for intermediate transfer member; the cleaning blade: elastic rubber material, cleaning roller.

TABLE 2

| | | Surface | Rz of | | Contact | | | | | | |
|---|---|---|---|---|---|---|---|---|---|---|---|
| | Photo- | Energy | Intermediate | Deformation | Angle of | | | | | | |
| Combi- | receptor | Lowering | Transfer | Amount of | Photo- | Inner | | Halftone | | | |
| nation | No. | Agent (Water | Member | Cleaning | receptor | Part | Character | Uneven- | Cleaning | Sharp- | |
| No. | (Ra:nm) | content:wt %) | (μm) | Brush (mm) | (°) | Omission | Scattering | ness | Ability | ness | Remarks |
| 1 | 4(47.3) | C(1.0) | 1.0 | 1.0 | 112 | A | A | A | A | A | Inv. |
| 2 | 4(47.3) | C(1.0) | 1.5 | 1.0 | 112 | A | A | A | A | A | Inv. |
| 3 | 4(47.3) | C(1.0) | 0.5 | 1.0 | 112 | A | A | A | A | A | Inv. |
| 4 | 4(47.3) | C(1.0) | 1.9 | 1.0 | 112 | B | B | A | A | B | Inv. |
| 5 | 4(47.3) | C(1.0) | 2.2 | 1.0 | 112 | C | B | A | A | C | Comp. |
| 6 | 4(47.3) | C(1.0) | 0.3 | 1.0 | 112 | C | B | C | B | C | Comp. |
| 7 | 1(17.4) | C(1.0) | 1.0 | 1.0 | 92 | C | C | C | A | C | Comp. |
| 8 | 2(34.5) | C(1.0) | 1.0 | 1.0 | 110 | A | A | A | A | A | Inv. |
| 9 | 3(23.5) | C(1.0) | 0.5 | 1.3 | 106 | B | A | A | A | B | Inv. |
| 10 | 5(73.6) | C(1.0) | 1.0 | 0.6 | 109 | A | A | A | A | A | Inv. |
| 11 | 6(97.3) | C(1.0) | 1.0 | 1.0 | 104 | B | B | A | A | B | Inv. |
| 12 | 7(111) | C(1.0) | 1.0 | 1.0 | 99 | C | C | A | A | C | Comp. |
| 13 | 8(1.6) | C(1.0) | 1.0 | 1.0 | 89 | C | C | C | A | C | Comp. |
| 14 | 4(47.3) | Non | 1.0 | 1.0 | 82 | C | C | C | C | C | Comp. |
| 15 | 4(47.3) | A(0.05) | 1.0 | 1.0 | 112 | A | A | A | A | A | Inv. |
| 16 | 4(47.3) | B(0.1) | 1.0 | 1.0 | 114 | A | A | A | A | A | Inv. |
| 17 | 4(47.3) | D(2.5) | 1.0 | 1.0 | 110 | A | A | A | A | A | Inv. |
| 18 | 4(47.3) | E(4.5) | 1.0 | 1.0 | 102 | B | B | B | B | B | Inv. |

As clearly from Table 2, the surface roughness Ra of photoreceptors are within the range of 0.02-0.1 μm (=20 nm-100 nm) of the present invention, and the surface roughness Rz of an intermediate transfer members are within the range of 0.4-2.0 μm, and in the combinations 1-4,8-11, and 15-18 in which the image formation was conducted by providing the surface energy lowering agent. The whole evaluation items including inner portion omission and character image scattering were improved. Especially, Combination No. 1-3, and 8, 10, 15, 16 and 17 in which Ra of a photoreceptor is 34.5-73.6 nm, Rz of an intermediate transfer member is 0.5-1.5 and the surface energy lowering agent has the water content of 2.5 or less weight %, have an outstanding improving effect. On the other hand, in Combination No. 5 whose surface roughness Rz of an intermediate transfer member is 2.2 μm, inner portion omission was generated, and sharpness was falling. In Combination No. 6 whose surface roughness Rz of an intermediate transfer member is 0.3 μm, since the secondary transferring ability of toner was lowered, inner portion omission and halftone unevenness occurred and sharpness was falling. In Combination No. 7 and No. 13 in which surface roughness Ra of photoreceptors was lower than 20 nm, the contact angle of photoreceptor was low, inner portion omission, character image scattering, and halftone unevenness occurred, and sharpness was falling.

On the other hand, in Combination No. 12 whose surface roughness Ra of photoreceptor was 111 nm, inner portion omission and character image scattering occurred, and sharpness was falling. Moreover, in Combination 14 in which the surface energy lowering agent was not provided, all evaluation items show low evaluation results.

As shown in the above-mentioned example, the improvement of toner transfer characteristics with an electro photographic method using an intermediate transfer member could be attained, and picture image faults generated from fall-off of toner transfer, such as inner portion omission and character image scattering, could be prevented, and an image forming apparatus of an electro photographic method with a good cleaning ability was able to be offered.

What is claimed is:

1. An image forming method, comprising the steps of:
developing a latent image formed on an electro-photographic photosensitive-member having a surface roughness Ra of 0.02 μm-0.1 μm with developer to form a toner image;
transferring the toner image developed as a visual image in the developing step onto an intermediate transfer member having a surface roughness Rz of 0.4 μm-2.0 μm;
transferring the toner image transferred onto the intermediate transfer member onto a recording material;
removing residual toner remaining on the surface of the electro-photographic photosensitive member; and
supplying a surface energy lowering agent onto the surface of the electro-photographic photosensitive member at least during an image forming process.

2. The image forming method of claim 1, wherein the surface energy lowering agent is a fatty acid metal salt.

3. The image forming method of claim 1, wherein the surface energy lowering agent has a water content amount of 5.0 wt % or less under an environmental condition of 30° C. in temperature, 80% RH in humidity.

4. The image forming method of claim 3, wherein Ra of the photosensitive member is 0.03 μm-0.08 μm and Rz of the intermediate transfer member is 0.5 μm-1.5 μm.

5. The image forming method of claim 1, wherein an agent supplying device is rotated to supply the surface energy lowering agent while being brought in contact with the photosensitive member in such a way that the contact portion of the agent supplying device is moved in the same direction with that of the surface of the photosensitive member and a surface velocity ratio of the photosensitive member and the agent supplying device is within a range of 1:1.1 to 1:2.

6. The image forming method of claim 2, wherein the fatty acid metal salt is a zinc stearate.

7. The image forming method of claim 2, wherein the surface layer of the photosensitive member contains particles having a number average primary particle diameter of 1 nm to 300 nm.

8. The image forming method of claim 7, wherein the number average primary particle diameter is 10 nm to 200 nm.

9. The image forming method of claim 7, wherein the particles contains at least one of silica, zinc oxide, titanium oxide, tin oxide, antimony oxide, indium oxide, bismuth oxide, indium oxide doped with tin, tin oxide doped with antimony and tantalum, zirconium oxide.

10. The image forming method of claim 1, wherein the surface energy lowering agent is supplied while a rotatable agent supplying device is brought in contact with the photosensitive member.

11. The image forming method of claim 10, wherein the agent supplying device is rotated such that the contact portion of the agent supplying device is moved in the same direction with that of the surface of the photosensitive member and a surface velocity ratio of the photosensitive member and the agent supplying device is within a range of 1:1.1 to 1:2.

12. The image forming method of claim 1, wherein the surface energy lowering agent has a water content amount of 5.0 wt % or less under an environmental condition of 30° C. in temperature, 80% RH in humidity.

13. The image forming method of claim 1, wherein Ra of the photosensitive member is 0.03 μm-0.08 μm.

14. The image forming method of claim 1, wherein Rz of the intermediate transfer member is 0.5 μm-1.5 μm.

15. An image forming apparatus, comprising:
an electro-photographic photosensitive member having a surface roughness Ra of 0.02 μm-0.1 μm wherein a latent image formed on the electro-photographic photosensitive member is developed with developer to form a toner image and;
an intermediate transfer member having a surface roughness Rz of 0.4 μm-2.0 μm, wherein the toner image developed as a visual image is transferred to the intermediate transfer member; and
an agent supplying device to supply a surface energy lowering agent onto the surface of the electro-photographic photosensitive member at least during an image forming process.

16. The image forming apparatus of claim 15, wherein the surface energy lowering agent is a fatty acid metal salt.

17. The image forming apparatus of claim 16, wherein the surface energy lowering agent has a water content amount of 5.0 wt % or less under an environmental condition of 30° C. in temperature, 80% RH in humidity.

18. The image forming apparatus of claim 16, wherein Ra of the photosensitive member is 0.03 μm-0.08 μm and Rz of the intermediate transfer member is 0.5 μm-1.5 μm.

19. The image forming apparatus of claim 15, wherein the agent supplying device is rotated to supply the surface energy lowering agent while being brought in contact with the photosensitive member in such a way that the contact portion of the agent supplying device is moved in the same direction with that of the surface of the photosensitive member and a surface velocity ratio of the photosensitive member and the agent supplying device is within a range of 1:1.1 to 1:2.

20. The image forming apparatus of claim 15, wherein the surface layer of the photosensitive member contains particles having a number average primary particle diameter of 1 nm to 300 nm.
